(19) United States
(12) Patent Application Publication
(10) Pub. No.: US 2006/0266221 A1
(43) Pub. Date: Nov. 30, 2006

(54) Air cleaning apparatus

(76) Inventors: Ronald G. Fink, Jupiter, FL (US); Walter Ellis, Jupiter, FL (US)

Correspondence Address: Joseph R. Englander, Esq.;CHRISTOPHER & WEISBERG, P.A., Suite 2040, 200 East Las Olas Boulevard, Fort Lauderdale, FL, 33301, US

(21) Appl. No.: 10/923,459

(22) Filed: Aug. 21, 2004

(51) Int. Cl. B01D 46/00

(52) U.S. Cl. 96/224

(57) ABSTRACT

An air cleaning apparatus comprising at least one UV light source and at least one target structure comprising a plurality of elongated tubular elements, whereby air cleaned by the UV light source in the presence of the target structure creates a zone of plasma including advanced oxidation products. The target structure incorporates at least one selected from the group consisting of titanium dioxide, copper, silver, and rhodium. The plurality of tubular elements is arranged in one or more matrices of elongated tubular elements. The matrices are optimized to allow air to flow through the elongated elements. The matrices comprise two parallel wall-shaped structures of stacked tubular elements, and the UV light source is located between two wall-shaped structures, whereby air flows through the tubular elements. A frame and an insulating UV light transparent cover generally surrounding the UV light source may be provided.

### FIELD OF THE INVENTION

This invention relates generally to air cleaning apparatuses, and more particularly to air cleaning apparatuses for the removal of contaminants such as pollutants, organisms, and odors from air.

### BACKGROUND OF THE INVENTION

Airborne pollutants, organisms, and odors are major sources of concern in indoor atmospheres. Pollutants such as dust are commonly removed by filtration. Organic pollutants and organisms are more difficult to remove by filtration, and other methods for removing these contaminants have been used. Various chemicals and other bactericidal agents have been used to combat organisms, while deodorants are supplied to the ambient air to control odors. Chemical and bactericidal agents must be replaced regularly and do not always effectively eliminate pollutants and organisms. Deodorants do not remove odors, but rather only mask them with a stronger and more acceptable scent.

Oxidation processes can be used to kill bacteria, mold, and viruses. They are also routinely used to react with odor causing chemicals, such as volatile organic compounds, and other inorganic and organic chemicals.

Ozone is a well known oxidizing agent. Ozone treatment has become a common treatment for freshening air and removing odors. The ozone can be generated by a variety of methods. A common method is to subject the oxygen in air to ultraviolet light at various wavelengths, including 185 nm. This wavelength of light, when it contacts oxygen, is known to cause a chemical reaction which generates ozone. The flow rate of oxygen, and the dimension and intensity of the light, are used to control the amount of ozone generation since intense amounts of ozone are undesirable for humans. Such systems do not, however, effectively remove organic pollutants and organisms.

While ultraviolet light energy at 185 nm can, when applied to air in an environment, create ozone gas, and ozone is a strong oxidizer, ozone in elevated quantities can be toxic to humans and animals as well as can have undesired reactions to an environment.

Germicidal ultraviolet rays (254 nm) have been used for inactivating microorganisms such as germs, viruses and bacteria. Ultraviolet light is dependable and can be easily installed. Germicidal ultraviolet light, however, is effective in reducing only the airborne microorganisms that pass directly through the light rays. Germicidal ultraviolet light unfortunately has little to no effect on gasses, vapors, or odors.

Hydroxyl radicals and super-oxide ions are known to oxidize volatile organic compounds (VOCs) that have been adsorbed on a catalyst surface. These radicals and ions will also kill and decompose adsorbed bioaerosols. This process is particularly desirable for treating VOCs because these materials are oxidized and are therefore eliminated rather than merely captured or removed from the air stream. A reactor using these products does not readily contaminate such as is the case with filtration, where the filters must be regularly changed or cleaned. It is preferred to form these radicals and ions in the form of a plasma which includes other oxidizing compounds.

Therefore a need to overcome the problems discussed above exists, and in particular, a need to provide a device and method for a significantly improved oxidizing process to reduce pollutants, microbes and odors in an environment remains to be solved.

### SUMMARY OF THE INVENTION

According to alternative preferred embodiments of the present invention, advanced oxidation products, such as hydroxyl radicals, ozone, hydroperoxide radicals, ozonide ions, hydroxides, super oxide ions and hydrogen peroxide can be formed by a new and novel apparatus and method. These advanced oxidation products comprise strong and effective oxidizers that react with undesired compounds in an environment such as microbes, odor-causing chemicals, and other inorganic and organic chemicals, to destroy and/or inactivate such undesired compounds.

It is therefore an object of this invention to address the problems cited above.

It is further an object of the invention to provide an air cleansing apparatus having improved efficacy.

It is still another object of the invention to provide an air cleansing apparatus that is easy to manufacture.

It is yet another object of the invention to provide improved targets for providing advanced oxidation products in an air cleansing apparatus.

It is further an object of the present invention to provide an air cleaning apparatus comprising at least one UV light source and at least one target structure comprising a plurality of elongated tubular elements whereby air cleaned by the UV light source in the presence of the target structure creates a zone of plasma including advanced oxidation products.

In an alternative embodiment of the invention, the target structure incorporates at least one selected from the group consisting of titanium dioxide, copper, silver, and rhodium.

In yet another embodiment of the invention, the plurality of tubular elements is arranged in one or more matrices of elongated tubular elements. The matrices may be optimized to allow air to flow through the elongated elements.

In another embodiment, two parallel wall-shaped structures of stacked tubular elements are provided, and the UV light source is located between two wall-shaped structures.

In still another embodiment, a cover generally surrounding the UV light source. In still another embodiment, the UV light source and the matrices are connected to a frame. The frame is preferred to be unitary, and the matrices are attached to the frame along the perimeter of each matrix, and may also be modular and easily replaced.

In still another embodiment, the frame further includes means for determining whether a UV light source is operating.

In yet another embodiment, the UV light source is located between two target structures. Alternatively, a plurality of UV light sources is located between two target structures. In another embodiment, at least one UV light source is located on either end of at least one target structure.

Another embodiment includes means for powering the UV light.

The target of the invention includes a matrix of tubular elements having a UV reactive coating. The coating may be hydrophilic, and preferably includes copper, silver, titanium oxide and rhodium. In still another embodiment, the surface area of the interior of the tubular elements in contact with the flux of one or more UV light sources is optimized for air cleansing. In yet another embodiment, the interior diameter of the tubular elements is optimized for air flow through the target. In yet still another embodiment, the interior diameter of the tubular elements is optimized for air flow through the target.

The method of the invention comprises the steps of providing one or more targets comprising tubular elements having at least one selected from the group consisting of copper, silver, titanium dioxide and rhodium and directing UV light toward said target. In still another embodiment, the targets comprise wall shaped matrices of tubular elements on opposite sides of a UV light source.

In accordance with these and other objects which will become apparent hereinafter, the instant invention will now be described with particular reference to the accompanying drawings.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is an exploded view of an air cleansing apparatus of the invention.

FIG. 2 is a cross section of a top plan view of the apparatus of the invention.

FIG. 3 is a perspective view of the invention.

FIG. 4 is a cut away side elevational view of the apparatus of the invention.

FIG. 5 is a schematic view of UV light emitted from UV light sources and impinging on tubular elements of the invention.

FIG. 6 is a schematic end view of an alternative embodiment of the invention.

FIG. 7 is a side view of an alternative embodiment of the invention.

FIG. 8 is a schematic end view of an alternative embodiment of the invention.

### DETAILED DESCRIPTION OF THE PREFERRED EMBODIMENTS

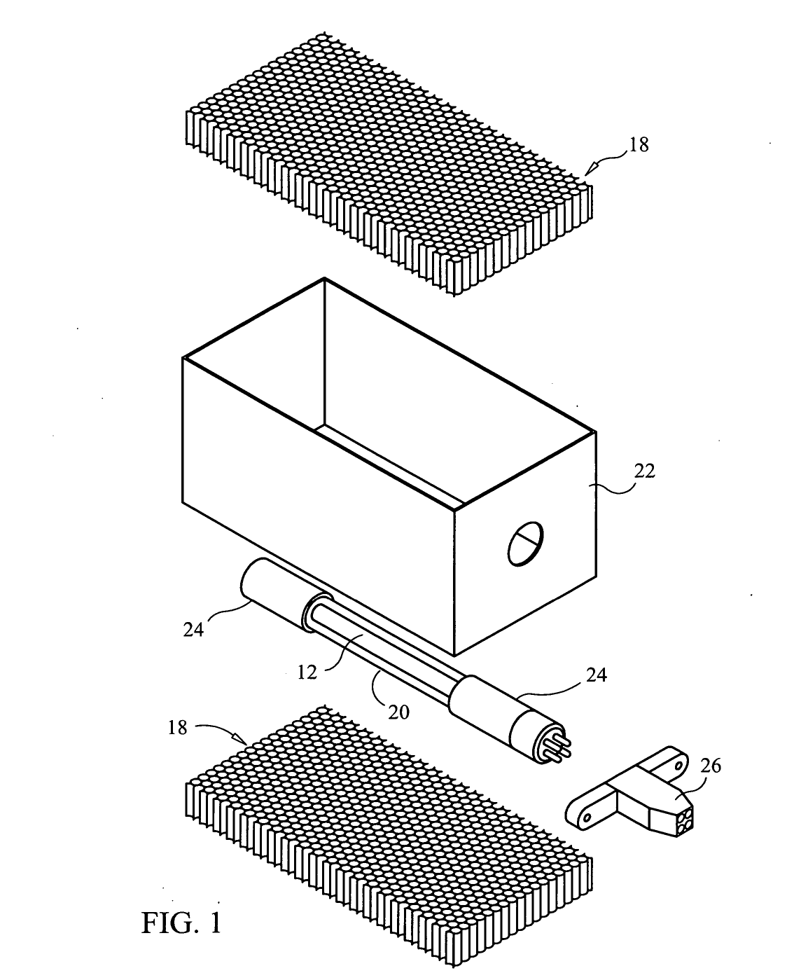

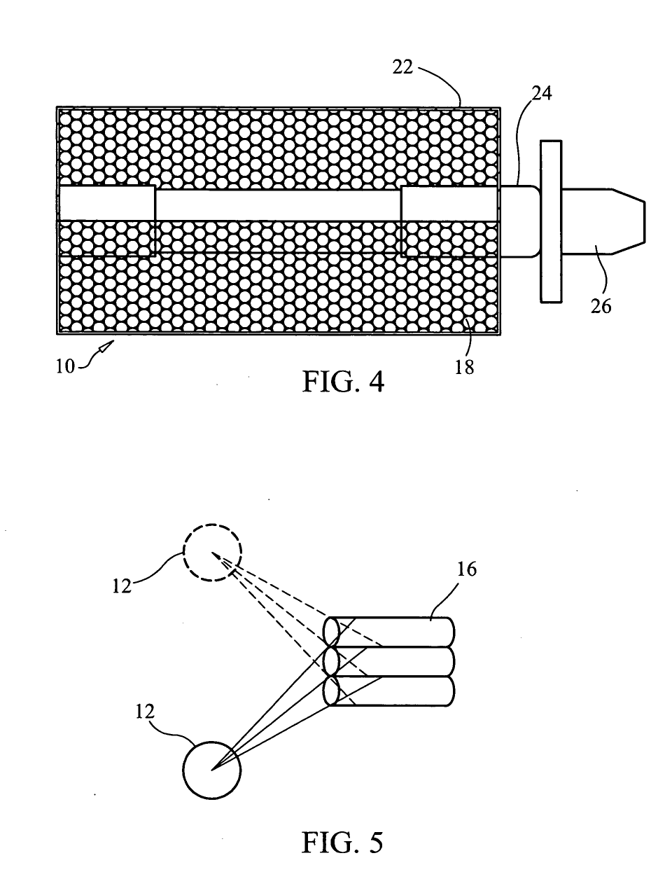

An air cleansing apparatus 10 for disinfecting and removing VOCs from air according to the invention is shown in FIGS. 1-8. The apparatus 10 includes at least one UV light source 12, and at least one target structure 14. The target structure comprises a plurality of elongated tubular elements 16. The elements 16 are arranged in one or more matrices 18. The matrices 18 preferably comprise two parallel wall-shaped structures of stacked tubular elements. It is preferred that the tubes are preformed into a matrix before being made part of the apparatus. The air is cleansed by the UV light from the source 12 in the presence of the target structure 14, creating a zone of plasma of advanced oxidation products including ozone, hydroperoxides, superoxides and hydroxyl radicals.

The UV light source is preferably a broad spectrum source, having high flux between 100 and 367 nm. The sources are also preferably made using argon gas with mercury, and have carbide filaments. It is further especially preferred that the UV light source emit UVX radiation, generally between 100-180 nm. The UVX radiation provides cleansing in its own right, as well the benefits it gives in the presence of the target as described below. The lamps are preferably 3 to 35 inches long, however, they may be of any length so long as the flux is sufficient and they are of sufficient size for the particular use.

The target structure 14 preferably incorporates materials at least one of which is selected from the group consisting of titanium dioxide, copper, silver, and rhodium. It may be preferred for maximum benefit for the cost to use titanium oxide only on the target structure. The target preferably is covered with a coating to include these materials. In the preferred embodiment, a silica gel incorporating these materials is placed on the target structure.

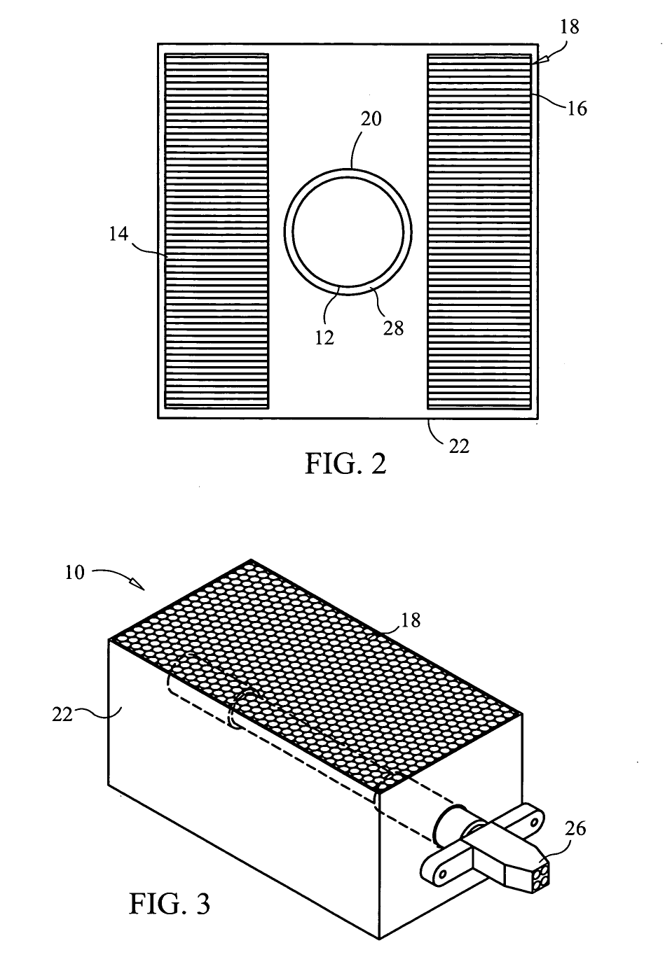

In the preferred embodiment, the matrices 18 of elongated tubular elements 16 are arranged in parallel orientation on opposite sides of the UV light source, as shown in FIGS. 1 and 2. The preferred size of a matrix is approximately 2 inches and wide and 3/16 to 0.5 inches deep. Thus, air flow through the apparatus is promoted and may be optimized. However, other orientations, such as a spiral, a baffled geometry or an equivalent, are also contemplated, and may be used to engender greater airflow though the apparatus 10.

In addition, the tubular elements are also optimized to promote airflow through the apparatus. In the preferred embodiment, the tubes are 3/16 to 0.5 inches deep. They are preferably 0.75 inches in diameter. They are generally rigid, and made from plastic such as polycarbonate. A hydrophilic coating, such as a silica gel or calcium chloride, is preferably applied to each tube. As stated above, the coating preferably includes at least one of which is selected from the group consisting of titanium dioxide, copper, silver, and rhodium.

If the tubes are pre-formed into a matrix, then the coating may be applied to the formed matrix. The coating is preferred to be a silica gel; however, equivalent materials are also contemplated.

As shown in FIG. 2, in the preferred embodiment, a UV light source 12 is located between two target structures 14, such as the wall-shaped matrix structures 18 described herein.

It is also preferred that the apparatus comprises a cover 20 generally surrounding the one or more UV light sources 12. The cover is preferably made from a UV transparent material, such as quartz glass. It is also preferred that the material is substantially rigid, to protect the location of the apparatus from potential glass or other material contamination from breakage of a UV light source.

The cover 20 also serves as an insulating means for the efficient operation of the apparatus 10. Optimally, the interaction between the UV light and the coating on a matrix works best at approximately 70 to 80 degrees Fahrenheit. Most UV light sources operate having a temperature of 160 degrees at the glass surface. This temperature is less than optimal and may be dangerous to an operator. The cover 20 provides an insulating air barrier around the UV light source so that the apparatus operates more closely to the optimum temperature.

As shown in FIGS. 1-4, the UV light source 12 and the matrices 18 are preferably connected to a frame 22. The frame 22 is preferred to be generally rigid, and may be made of metal, plastic or an equivalent material. The matrices 18 are preferably attached at the perimeter to the frame using an adhesive such as one having methacrylate. However, the matrix may alternatively be attached using equivalent adhesives or complementary fittings or equivalent means for attachment. Also, for strength and ease in manufacture, the frame 22 is preferably unitary in form. Furthermore, it may also be preferred that the frame is modular and easily replaced. In addition, the frame further includes means for determining whether a UV light source is operating. For example, a polycarbonate stick may transmit light from the UV source to the outside of the apparatus. Since polycarbonate does not transmit UV light but does transmit blue light, the function of the UV light can be determined by the blue glow of the stick. Other equivalent means for determining function of the UV light are also contemplated.

As shown in FIG. 5, depending upon the orientation and the geometry of the UV light source 12, the tubular element 16 and the matrix 18, only a portion of the end of a tubular element may be impinged by the flux of the emitted UV light. It is preferred that the surface area of the interior of the tubular elements in contact with the flux of one or more UV light sources is optimized for air cleansing. Alternatively, the configuration of the apparatus elements may be optimized for air flow. For air flow optimization, the size of the interior diameter of the tubular elements would be especially significant.

Thus, in an alternative embodiment, as shown in FIGS. 5 through 7, it may be preferred to have a plurality of UV light sources 12 emitting UV light in the presence of a matrix 16 located between two target structures 14. Similarly, to make more efficient use of the active surface areas of the tubular elements in the matrices, it may be preferred to have at least one UV light source 12 located on either end of at least one target structure 14. This configuration is illustrated in FIG. 8. Thus, two ends of a tubular element are impinged upon by UV light. Additional configurations and geometries to best utilize the structure are also contemplated herein.

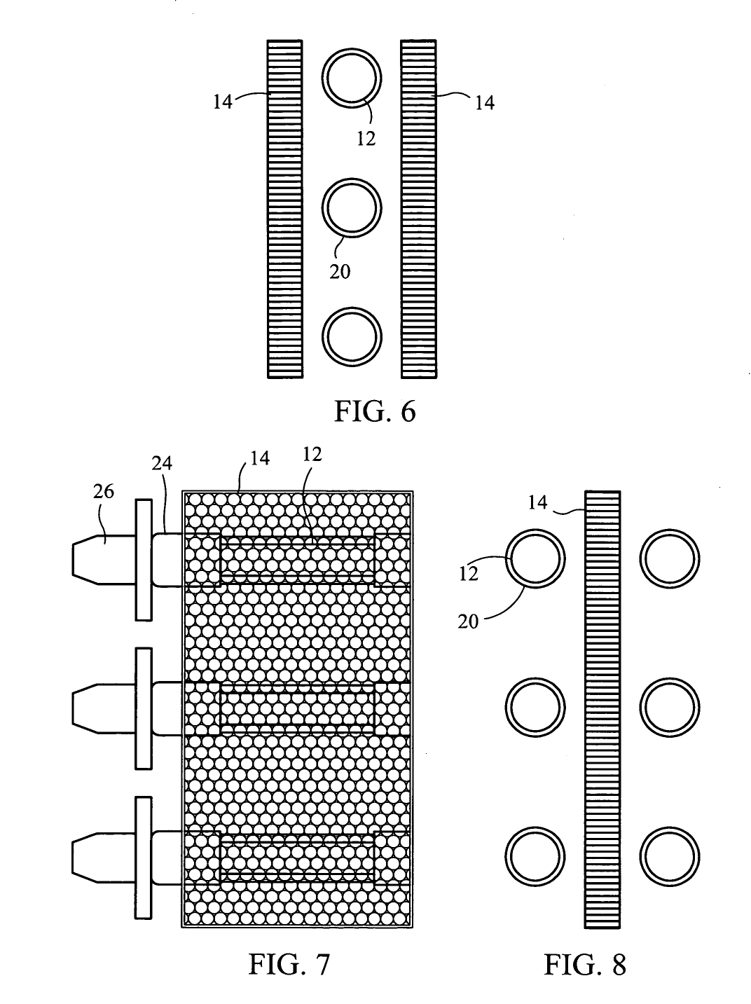

In addition, it may also be preferred that a connector 24 is used to house to secure the UV light source 12, and the cover 20, if used, to the frame 22. It may also be used to provide separation between the cover 20 and the UV light source 12. The connector 24 may be used on both ends of the UV light source, as shown in FIGS. 1 and 7.

In the preferred embodiment, the apparatus 10 includes means for powering the UV light 26. As shown in FIGS. 1 and 7, a standard power coupling is provided to connect the UV light source to a power supply, such as an outlet or electrical circuit board.

In operation, air flows through the tubular elements of the apparatus. As air passes in the vicinity of the targets in the presence of UV light, it encounters sterilizing UV light, as well as a cleansing plasma. The light and the plasma remove pollutants from the air, which then flows out of the apparatus. Thus, in the method of the invention, the following steps are to be taken. First, one or more targets comprising tubular elements having at least one selected from the group consisting of copper, silver, titanium dioxide and rhodium is provided. Then, UV light is directed toward said target. Preferably the targets comprise wall shaped matrices of tubular elements on opposite sides of a UV light source.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. An air cleaning apparatus comprising:
at least one UV light source; and
at least one target structure comprising a plurality of elongated tubular elements,
whereby air cleaned by the UV light source in the presence of the target structure creates a zone of plasma including advanced oxidation products.

2. The apparatus of claim 1, wherein the target structure incorporates at least one selected from the group consisting of titanium dioxide, copper, silver, and rhodium.

3. The apparatus of claim 1, wherein the plurality of tubular elements is arranged in one or more matrices of elongated tubular elements.

4. The apparatus of claim 3, wherein the matrices are optimized to allow air to flow through the elongated elements.

5. The apparatus of claim 4, wherein the matrices comprise two parallel wall-shaped structures of stacked tubular elements, and
the UV light source is located between two wall-shaped structures,
whereby air flows through the tubular elements.

6. The apparatus of claim 5, further comprising a cover generally surrounding the UV light source.

7. The apparatus of claim 5, wherein the UV light source and the matrices are connected to a frame.

8. The apparatus of claim 7, wherein the frame is unitary, and the matrices are attached to the frame along the perimeter of each matrix.

9. The apparatus of claim 8, wherein the apparatus is frame is modular and easily replaced.

10. The apparatus of claim 7, wherein the frame further includes means for determining whether a UV light source is operating.

11. The apparatus of claim 1, wherein the UV light source is located between two target structures.

12. The apparatus of claim 1, wherein a plurality of UV light sources is located between two target structures.

13. The apparatus of claim 1, wherein at least one UV light source is located on either end of at least one target structure.

14. The apparatus of claim 7, further including means for powering the UV light.

15. A target for an air cleaning apparatus, comprising:
a matrix of tubular elements having a UV reactive coating.

16. The target of claim 15, wherein the coating is hydrophilic.

17. The target of claim 16, wherein the coating includes copper, silver, titanium oxide and rhodium.

18. The target of claim 16, wherein the surface area of the interior of the tubular elements in contact with the flux of one or more UV light sources is optimized for air cleansing.

19. The target of claim 16, wherein the interior diameter of the tubular elements is optimized for air flow through the target.

20. The target of claim 18, wherein the interior diameter of the tubular elements is optimized for air flow through the target.

21. An air cleaning apparatus comprising:
means for emitting UV light; and
a plurality of tubular means for providing a target structure for creating advanced oxidation products in the presence of UV light.

22. The apparatus of claim 21, further including means for covering the means for emitting UV light, whereby an insulating air layer is created around the means for emitting UV light.

23. The apparatus of claim 21, further comprising a means for framing the means for emitting UV light between two parallel means for providing a target structure.

24. The apparatus of claim 23, wherein the means for providing a target structure comprises parallel matrices of tubular elements

25. A method for cleaning air, comprising the steps of:
providing one or more targets comprising tubular elements having at least one selected from the group consisting of copper, silver, titanium dioxide and rhodium; and
directing UV light toward said target.

26. The method of claim 25, wherein the targets comprise wall shaped matrices of tubular elements on opposite sides of a UV light source.
